(19) United States
(12) Patent Application Publication
(10) Pub. No.: US 2008/0255964 A1
(43) Pub. Date: Oct. 16, 2008

(54) METHOD AND SYSTEM OF SEARCHING ITEMS USING EQUITY

(76) Inventor: Trevor Robert Milton, St. George, UT (US)

Correspondence Address: TERRENCE J. EDWARDS;CLAYTON, HOWARTH & CANNON, P.C., P.O. BOX 1909, SANDY, UT, 84091, US

(21) Appl. No.: 12/099,018

(22) Filed: Apr. 7, 2008

Related U.S. Application Data
(60) Provisional application No. 60/922,242, filed on Apr. 5, 2007.

(51) Int. Cl. G06F 17/30

(52) U.S. Cl. 705/27

(57) ABSTRACT

A method of marketing items, such as vehicles, is disclosed. The method may include creating a vehicle listing for a user by receiving input from the user relating to a specific vehicle. The listing may be created over a global computer network through a user interface such as a webpage. The user input may include an asking price for the vehicle, information relating to the type, make, model and specifications of the vehicle, as well as mileage and condition of the vehicle. As part of the method, access may be provided to a vehicle information database that comprises average retail values, average trade-in values and other vehicle data for comparison. The user input may then be compared to the vehicle information database, resulting in a vehicle listing for marketing the vehicle to potential purchasers. The vehicle listing may illustrate an amount of equity in that particular vehicle, which may be calculated by subtracting the asking price from the average national retail price, thereby indicating to a potential purchaser the value in the vehicle. Multiple listings may then be gathered in a database, which may be searched and accessed by the public and potential purchasers.

### CROSS-REFERENCE TO RELATED APPLICATIONS

This application claims the benefit of U.S. Provisional Application No. 60/922,242 filed Apr. 5, 2007, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### BACKGROUND

1. The Field of the Invention

The disclosure relates generally to methods for marketing items, and more particularly, but not necessarily entirely, to methods for marketing vehicles through listings comprising an amount of equity or value in a vehicle.

2. Description of Related Art

It is common practice for individuals and businesses to buy and sell goods over the Internet. Individuals wishing to sell items such as vehicles may place advertisements on the Internet for the general public to view. However, such methods for selling vehicles require potential purchasers to navigate through multiple webpages to determine the average retail value, the average trade-in value, and the average private-party sales price for a particular vehicle. The known methods are time consuming and causes potential purchasers unwarranted frustration trying to determine the value or deal of a particular vehicle. The time and frustration only increase as different makes and models of vehicles are selected, requiring potential purchasers to repeat the research to determine the value or deal of a particular vehicle.

The result is vehicles are often on the market longer than a seller desires because potential purchasers may forget about the listing or may be attracted to a different vehicle after conducting the required research. Thus, individuals wishing to sell a vehicle are often looking for inexpensive, timely and effective methods for selling their vehicles to other individuals at a fair price.

The prior art is thus characterized by several disadvantages that may be addressed by the disclosure. The disclosure may minimize, and in some aspects may eliminate, the above-mentioned failures, and other problems, by utilizing the methods and features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a flow chart illustrating useful steps of a method of the disclosure;

FIG. 2 is another flow chart illustrating useful steps of another method of the disclosure;

FIG. 3 is an illustration of a system of the disclosure;

FIG. 4 is an illustration of another system of the disclosure;

FIG. 5 is an a illustration of another system of the disclosure; and

FIG. 6 is an illustration of a webpage for display to a user in accordance with the principles of the disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present methods for marketing items, such as a vehicle, and method of selecting items for purchase, such as a vehicle, are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

It will be appreciated that the term “vehicle,” as used herein, shall be construed broadly to include any means of conveyance, including automobiles, such as cars, trucks, vans, sport-utility vehicles, classic cars, hot rods and others, snowmobiles, motorcycles, off road vehicles including all terrain vehicles, personal watercraft, boats, recreation vehicles, trailers, truck campers, motor homes, camping trailers, aircraft and the like.

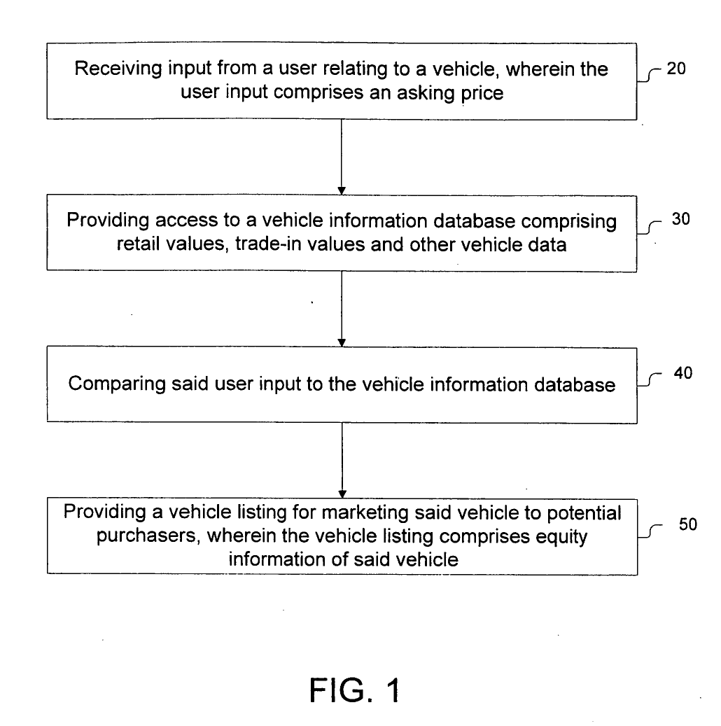

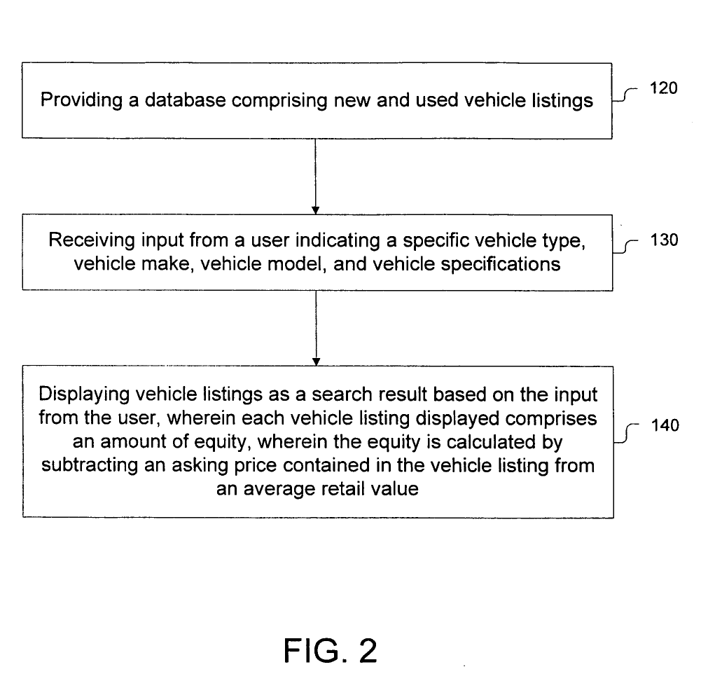

Referring now to FIGS. 1 and 2, two flow charts are shown, each including one embodiment of useful method steps for use in accordance with the principles of the disclosure. It will be appreciated that some embodiments of the disclosure may not include all of the steps depicted in FIGS. 1 and 2, and that other embodiments of the disclosure may include additional steps that are not depicted in FIGS. 1 and 2. It will likewise be appreciated that the order of the steps recited may vary in accordance with the principles of the disclosure. Moreover, it is to be understood that although the embodiments depicted in FIGS. 1 and 2 may be discussed in the context of a method of marketing a vehicle or method of selecting a vehicle for purchase, the concepts of the disclosure are useful for the marketing, sell and selection of various different goods or services.

The embodiment of FIG. 1 may include the step, indicated at 20, of receiving input from a user relating to a vehicle, wherein the user input comprises an asking price and other vehicle information relating to the specific vehicle, such as vehicle type, vehicle make, vehicle model, and vehicle specifications. The vehicle type may refer to the category of vehicle, and may be for example automobiles, such as cars, trucks, vans, sport-utility vehicles, classic cars, hot rods and others, snowmobiles, motorcycles, off road vehicles including all terrain vehicles, personal watercraft, boats, recreation vehicles, trailers, truck campers, motor homes, camping trailers and aircraft.

The vehicle make may refer to the company who manufactured the particular vehicle. For example, in automobiles, the make may include companies such as Acura, Audi, BMW, Buick, Cadillac, Chevrolet, Dodge, Ford and many others. The vehicle model may refer to the name of the particular line of vehicles that a manufacturer produces. For example, the models that Audi manufactures include the following: the A3 model, the A4 model, the A6 model, the A8 model, the Q7 model and others. The vehicle trim and specifications include the options and features of that may be added to a given model, such as the size of the engine, the drive-train, safety features, comfort and convenience features, music and entertainment features and packages, interior and exterior features, tire size and wheel type.

It will be appreciated that the input from the user may be obtained through a user interface. For example, the user interface may be part of a webpage or website where the user may be guided and prompted by the format and layout of the webpage or website for specific information, such as the user's personal information and contact information, and the vehicle description that is to be listed and as described above. The interface may be used for transmitting information over a global computer network, such as the internet, for receiving the data input from the user.

Further, the embodiment of FIG. 1 may include the step, indicated at 30, of providing access to a vehicle information database comprising retail values, trade-in values and other vehicle data. More specifically, the vehicle information database may be comprised of average high retail values, average low retail values, average high trade-in values, and average low-trade-in values, wherein the values are based on national sales data. It will be appreciated that the vehicle information database may be integrated into a webpage or a website for use by potential purchasers and sellers. For example, the vehicle pricing and information may be purchased or licensed from N.A.D.A. Guides, which is published by the National Automobile Dealers Association. The N.A.D.A. is the largest provider of vehicle information and provides its information to a majority of the nation's leading banks, credit unions, fleet and lease organizations, dealers, insurance companies, government agencies and financial institutions. Thus, the vehicle information database obtained from the N.A.D.A. Guides may be integrated into the user interface.

Further, the embodiment of FIG. 1 may include the step, indicated at 40, of comparing the user input obtained through the interface to the vehicle information database. This step may include comparing the vehicle type, vehicle make, vehicle model and vehicle specifications to the vehicle information database comprising national averages for similar vehicles.

Finally, the embodiment of FIG. 1 may include the step, indicated at 50, of providing a vehicle listing for marketing the vehicle to potential purchasers, wherein the vehicle listing comprises equity information of said vehicle. It is to be understood that the equity information of the vehicle listing may be calculated by subtracting the asking price obtained from the user during the user input step from an average retail value of the vehicle as obtained from the N.A.D.A. Guides and database containing such information. Further, the vehicle listing may include the retail values, the trade-in values and the equity information, thereby providing potential purchasers and consumers with immediate feedback regarding the overall value of that specific vehicle.

Referring now to the embodiment of FIG. 2, the flow chart of FIG. 2 illustrates at least some of the steps of selecting a vehicle for purchase. Specifically, the method of FIG. 2 may include the step, indicated at 120, of providing a database comprising new and used vehicle listings. It will be appreciated that the vehicle listings may be obtained as described above in reference to the method of FIG. 1. However, it is not necessary that the vehicle listings be obtained using the above described method. The database of vehicle listings may be provided using a user interface, such as a web interface, for ease of access and without regard to locality of the user.

Further, the embodiment of FIG. 2 may include the step, indicated at 130, of receiving input from a user indicating a specific vehicle type, vehicle make, vehicle model, and vehicle specifications as described above in connection with FIG. 1. It will be appreciated that such information may be transmitted over the internet and may be stored, temporarily on a server or other storage device. Once the parameters set by the user are input using the interface, a search of the database of new and used vehicles may be conducted where information, such as vehicle listings, meeting the specified criteria or parameters may be gathered as a search result.

Finally, the embodiment of FIG. 2 may include the step, indicated at 140, of displaying vehicle listings as a search result based on the input from the user, wherein each vehicle listing displayed comprises an amount of equity, wherein the equity is calculated by subtracting an asking price contained in the vehicle listing from an average retail value.

It is to be understood that a database may be provided on a computer, server, or storage device in any manner known to those skilled in the art. The database may be connected to a network, such as a global computer network, the internet, a wide-area network or a local area network, or any combination of such networks. Alternatively, one embodiment of the disclosure may include a database on a computer without a connection to a network. It will also be understood that wireless data transmissions may be used within the scope of the disclosure. It will be understood that access to the database may be restricted or a fee may be charged for access to the database. The database may contain information as described herein above and may relate to vehicle information to aid in the determination of the amount of equity (as that term is used herein) in a particular vehicle.

It will be appreciated that the structure and apparatus disclosed herein is merely one example of a means for performing the specified function, and it should be appreciated that any structure, apparatus or system for the function which performs functions the same as, or equivalent to, those disclosed herein are intended to fall within the scope of a means for performing the specified function, including those structures, apparatus or systems for the function which are presently known, or which may become available in the future. Anything which functions the same as, or equivalently to, a means for performing the specified function falls within the scope of these elements.

In accordance with the features and combinations described above, a useful method of marketing items, may include the steps of:

receiving input from a user relating to a vehicle, wherein the user input comprises an asking price;

providing access to a vehicle information database comprising retail values, trade-in values and other vehicle data;

comparing said user input to the vehicle information database; and

providing a vehicle listing for marketing said vehicle to potential purchasers, wherein the vehicle listing comprises equity information of said vehicle.

In accordance with the features and combinations described above, another useful method of selecting items for purchase, may include the steps of:

providing a database comprising new and used vehicle listings;

receiving input from a user indicating a specific vehicle type, vehicle make, vehicle model, and vehicle specifications; and

displaying vehicle listings as a search result based on the input from the user, wherein each vehicle listing displayed comprises an amount of equity, wherein the equity is calculated by subtracting an asking price contained in the vehicle listing from an average retail value.

In accordance with the features and combinations described above, a useful system for marketing items may comprise:

a means for receiving input from a user, wherein the input is related to a vehicle;

a means for providing access to a vehicle information database;

a means for comparing the user input to the vehicle information database;

a means for providing equity information in a vehicle listing for marketing said vehicle to potential purchasers.

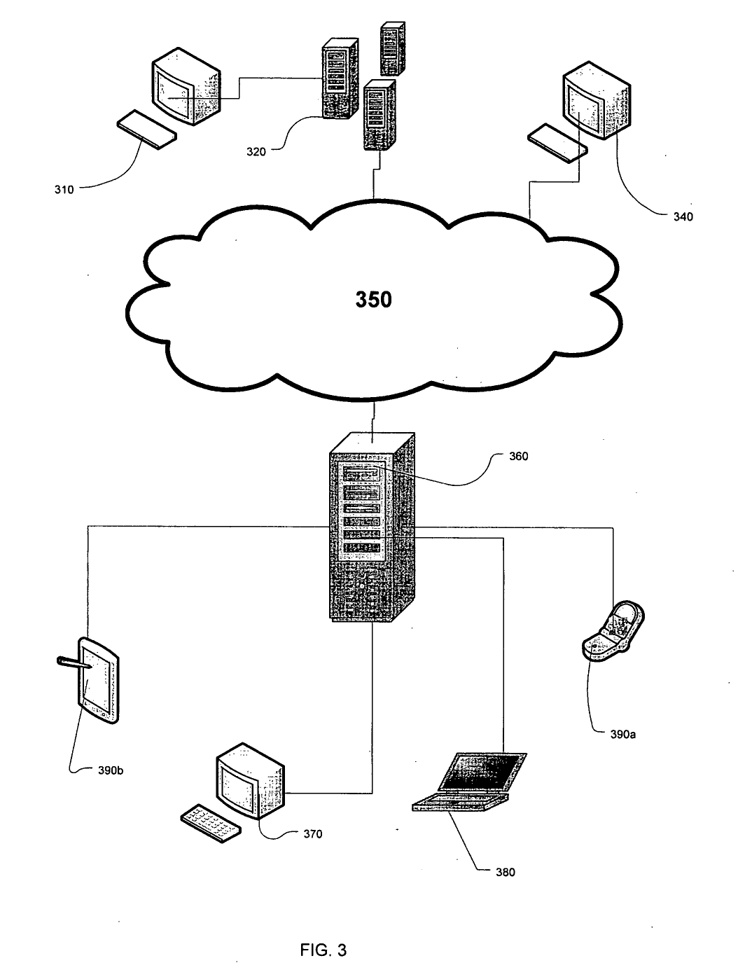

FIG. 3 illustrates an embodiment of marketing items based on the items equity characteristics as implemented on a network. The embodiment of FIG. 3 may include a terminal 310 for receiving input from a user relating to a vehicle, wherein the user may input an asking price and other vehicle information relating to the specific vehicle, which is then processed by a server or server cluster 320, such inputs may comprise, vehicle type, vehicle make, vehicle model, and other vehicle specifications. The vehicle type may refer to the category of vehicle, and may be for example automobiles, such as cars, trucks, vans, sport-utility vehicles, classic cars, hot rods and others, snowmobiles, motorcycles, off road vehicles including all terrain vehicles, personal watercraft, boats, recreation vehicles, trailers, truck campers, motor homes, camping trailers and aircraft.

A computer 340 may also be used for accessing a sever 320 and may make said access over the internet 350. Server 320 may also be connected to the internet and may be set to use proprietary and non-proprietary protocols for providing and receiving data from the internet 350. At a computer 340 the user may input an asking price and other vehicle information relating to the specific vehicle which is then processed by a server or server cluster 320, such inputs may comprise, vehicle type, vehicle make, vehicle model, and other vehicle specifications. The vehicle type may refer to the category of vehicle, and may be for example automobiles, such as cars, trucks, vans, sport-utility vehicles, classic cars, hot rods and others, snowmobiles, motorcycles, off road vehicles including all terrain vehicles, personal watercraft, boats, recreation vehicles, trailers, truck campers, motor homes, camping trailers and aircraft.

The vehicle make may refer to the company who manufactured the particular vehicle. The vehicle model may refer to the name of the particular line of vehicles that a manufacturer produces. The vehicle trim and specifications include the options and features of that may be added to a given model, such as the size of the engine, the drive-train, safety features, comfort and convenience features, music and entertainment features and packages, interior and exterior features, tire size and wheel type.

A non-proprietary server 360 may be accessed through the internet 350. Servers 360 may process databases on non-proprietary sites generally for the purpose of organizing and distributing non-proprietary data over the internet 350. Server 360 may be used for the distribution of information processed and developed on server 320 and computer 340. Server 360 may directly or through the internet convey data to computer 370, mobile computer 360, and dedicated mobile devices 390a and 390b.

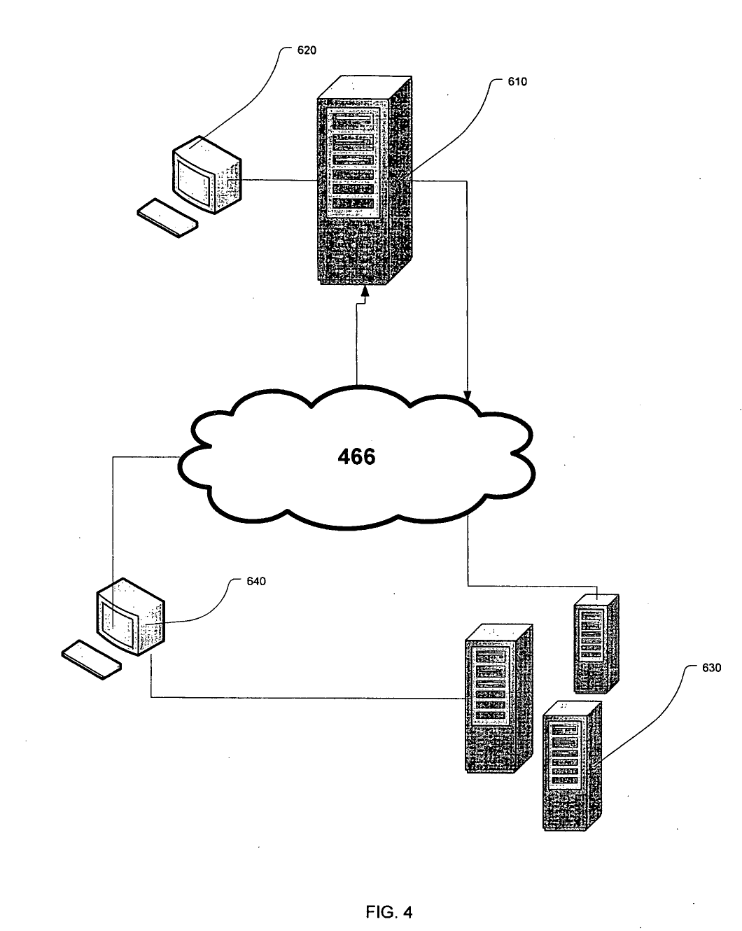

An embodiment illustrated in FIG. 4 may include a sever 401 accessed by a terminal 402 for providing access to a vehicle information database comprising retail values, trade-in values and other vehicle data stored in memory and storage thereon. Another server or server cluster 403 having a vehicle information database of average high retail values, average low retail values, average high trade-in values, and average low-trade-in values, wherein the values are based on national sales data. A terminal 404 may be connected to serve 403 thought the internet 466. Such information may be entered at a terminal 404 or a plurality of terminals. Terminal 404 may display the vehicle information database in the form of webpage or a website for use by potential purchasers and sellers. For example, the vehicle pricing and information may be purchased or licensed from N.A.D.A. Guides, which is published by the National Automobile Dealers Association. The N.A.D.A. is the largest provider of vehicle information and provides its information to a majority of the nation's leading banks, credit unions, fleet and lease organizations, dealers, insurance companies, government agencies and financial institutions. Thus, the vehicle information database obtained from the N.A.D.A. Guides may be integrated into the user interface.

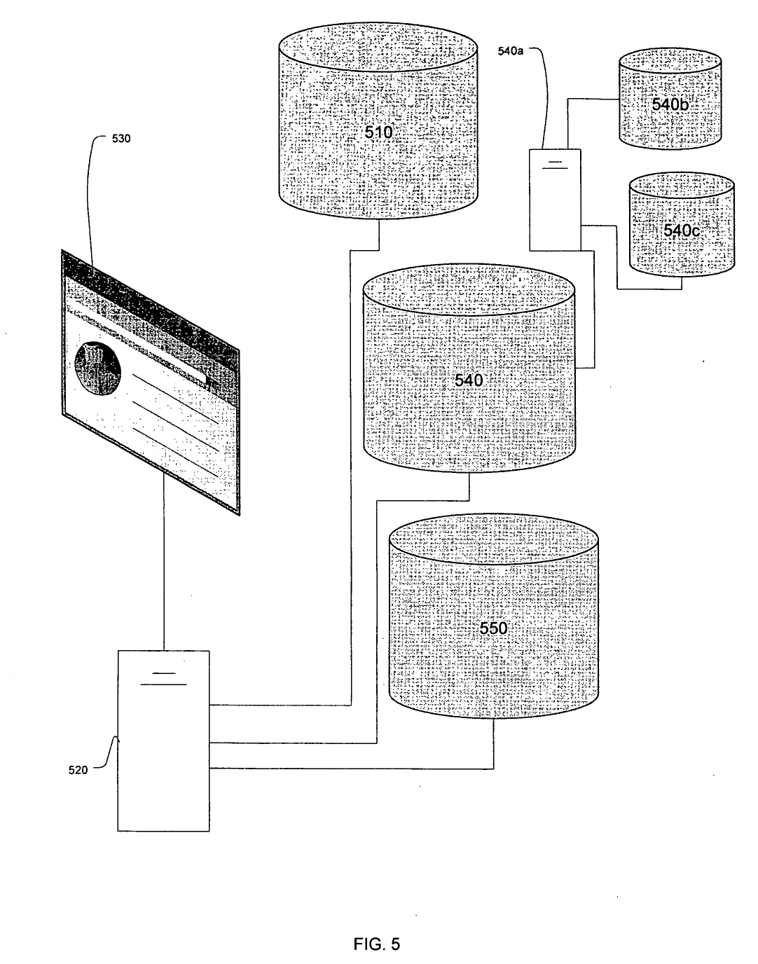

The embodiment of FIG. 5 illustrates a data management structure for managing the data. A data base 510 may store and organize information related to sources accessed for providing value information. Such value information may include non-proprietary and proprietary sources that may be desirable to a user. In operation, a processor 520 will execute instructions provided by the operator or by a computer program. Data from database 510 is accessed by the processor 520 and may direct the processor to access additional data of database 540 and database 550. Database 540 may store multiple data types that may be stored on integrated or sub-data bases 540b and 540c. Sub-databases may be accessed by a sub-processor 540a. Data base 540 may contain information such as item attributes and item value information. Data base 550 may include standard item values. Processor 520 may direct data to be displayed and formatted in a web page 530. In use, a user may select an instruction from web page 530 and the instruction is executed by the processor 520. Processor 520 accesses database 510 and select a source for item information. The processor 520 may then access data base 540 to retrieve item attribute information and item value information for an actual item on the market. In this embodiment a sub-processor 540a may access sub-database 540b storing attribute information. Sub processor 540a may access sub-database 540c storing value information. Sub-processor 540a may correlate the value and attribute data in a predetermined form that constitutes the database 540. Processor 520 may access database 550, which may contain standardized or known item values over time. The processor 520 may then compare the data accessed from databases 510, 540, and 550. If the processor determines that the item data from database 540 has greater value than corresponding item value of data base 550 the processor 520 may cause an indicator to be displayed in web page 530.

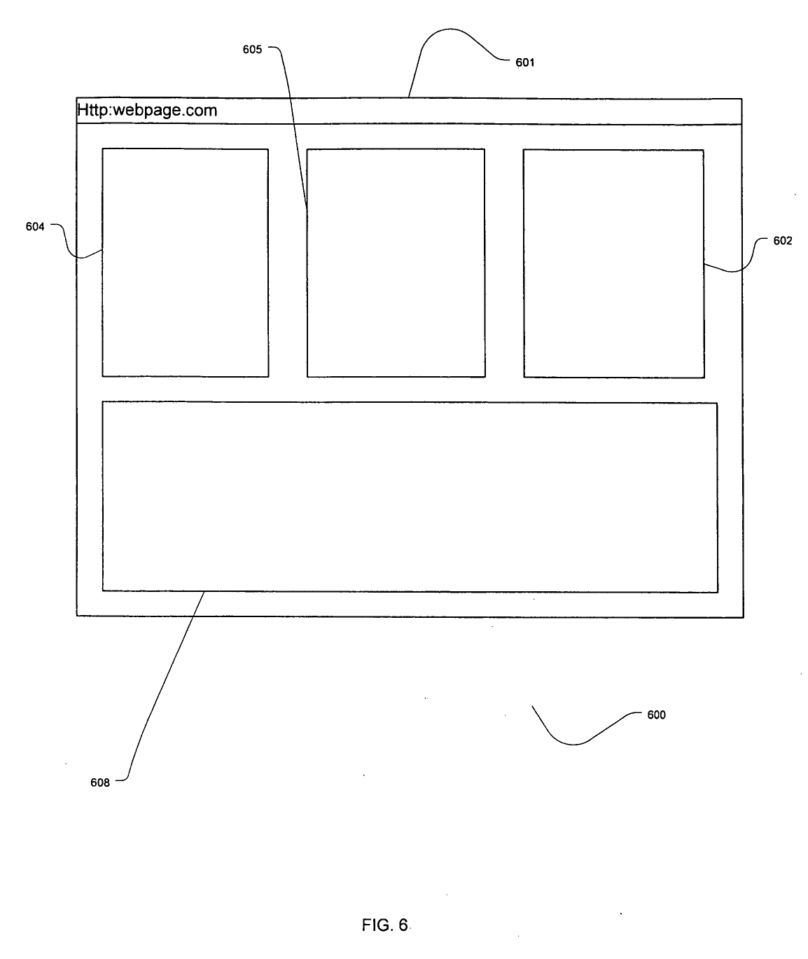

FIG. 6 illustrates an embodiment of a web page for providing a vehicle listing for marketing the vehicle to potential purchasers, wherein the vehicle listing comprises equity information of said vehicle. It is to be understood that the equity information of the vehicle listing may be calculated by comparing values of databases with in a system such as the retail value of the vehicle as obtained from N.A.D.A. Guides and averaging databases also containing such information. Such data to be displayed on the web page 600 may comprise the vehicle listing values or values of an item, the trade-in values and the equity information, thereby providing potential purchasers and consumers with immediate feedback regarding the overall value of that specific vehicle. Referring now to FIG. 6 an embodiment of a web page 600 will be discussed further. An address portion 601 may be provided wherein an internet address my be inserted and may direct the nature of databases accessed by the system wherein it resides. A portion 602 may be provided wherein item attributes input by the user may be displayed. A portion 604 may be provided wherein standardized data may be provided to a user. A portion 605 may be provided wherein the equity information may be provided. A portion 608 may be provided where history or summary data may be displayed. It should be understood that additional portions may be provided to convey information to a user, such as advertizing and related or unrelated information. It should also be understood that different configurations are within the scope of this disclosure, for varying devices whether connected or wireless.

It will be appreciated that the information from and to the user may be conveyed to all objects within the system simultaneously or separately. For example, the user interface may be part of a webpage or website where the user may be guided and prompted by the format and layout of the webpage or website for specific information, such as the user's personal information and contact information, and the vehicle description that is to be listed and as described above. The interface may be used for transmitting information over a global computer network, such as the internet, for receiving the data input from the user.

Those having ordinary skill in the relevant art will appreciate the advantages provide by the features of the disclosure. For example, it is a potential feature of the disclosure to provide a method of marketing an item, such as a vehicle, that is simple to use. Another potential feature of the disclosure is to provide an internet interface where a consumer may create a vehicle listing based on an amount of equity in the vehicle, where the equity is calculated by subtracting the listing price from the N.A.D.A. Guides' or other database's retail price. It is yet another potential feature to provide a method of selecting items for purchase that is easy to use. Another potential feature of the disclosure to display vehicle listings as a search result based on input from a user, wherein each vehicle listing displayed comprises an amount of equity that is calculated by subtracting an asking price contained in the vehicle listing from an average retail value.

In the foregoing Detailed Description of the Disclosure, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the disclosure.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method of marketing a vehicle comprising the steps of:
(a) receiving input from a user relating to a vehicle, wherein the user input comprises an asking price;
(b) providing access to a vehicle information database comprising retail values, trade-in values and other vehicle data;
(c) comparing said user input to the vehicle information database; and
(d) providing a vehicle listing for marketing said vehicle to potential purchasers, wherein the vehicle listing comprises equity information of said vehicle.

2. The method of claim 1, wherein step (a) further comprises providing a user interface for receiving input from the user.

3. The method of claim 2, wherein the user interface is part of a webpage for transmitting information over a network for receiving input from the user.

4. The method of claim 1, wherein the vehicle information database of step (b) further comprises average high retail values, average low retail values, average high trade-in values, and average low-trade-in values, wherein the values are based on averaged data.

5. The method of claim 1, wherein step (b) further comprises integrating the vehicle information database into a webpage.

6. The method of claim 1, wherein the user input from step (a) comprises information regarding a specific vehicle type, vehicle make, vehicle model, and vehicle specifications.

7. The method of claim 6, wherein step (c) further comprises comparing the vehicle type, vehicle make, vehicle model and vehicle specifications to the vehicle information database comprising averages for similar vehicles.

8. The method of claim 1, wherein the type of vehicles comprise automobiles, snowmobiles, motorcycles, all terrain vehicles, off road vehicles, personal watercraft, boats, recreation vehicles, trailers, truck campers, motor homes, camping trailers and aircraft.

9. The method of claim 1, wherein the equity information of the vehicle listing in step (d) is calculated by subtracting the user input from an average retail value of said vehicle.

10. The method of claim 9, wherein the retail values, the trade-in values and the equity information are provided as part of the vehicle listing, thereby providing purchasers with immediate feedback regarding overall value.

11. A method of selecting a vehicle for purchase comprising the steps of:
(a) providing a database comprising new and used vehicle listings;
(b) receiving input from a user indicating a specific vehicle type, vehicle make, vehicle model, and vehicle specifications; and
(c) displaying vehicle listings as a search result based on the input from the user, wherein each vehicle listing displayed comprises an amount of equity.

12. The method of claim 11, wherein each vehicle listing comprises an average trade-in value, average-retail value, average high trade-in value; average high-retail value for comparing the amount of equity in a particular vehicle, thereby providing purchasers with immediate feedback regarding overall value of that particular vehicle.

13. The method of claim 11, wherein step (b) further comprises providing a user interface for receiving input from the user.

14. The method of claim 13, wherein the user interface is part of a webpage over a network for receiving input from the user.

15. The method of claim 12, wherein the average values are based on national sales data.

16. The method of claim 11, wherein the type of vehicles comprise automobiles, snowmobiles, motorcycles, all terrain vehicles, off road vehicles, personal watercraft, boats, recreation vehicles, trailers, truck campers, motor homes, camping trailers and aircraft.

17. The method of claim 11, wherein step (b) further comprises transmitting the user input information over a network and storing said information.

18. The method of claim 17, wherein a user sets and inputs specific search criteria using a user interface, and thereafter a search of the database of new and used vehicles is conducted resulting in vehicle listings meeting the specified criteria being gathered as a search result.

19. A system for marketing items, said system comprising:
a terminal for receiving input from a user, wherein the input is related to a vehicle;
access to a vehicle information database;
a processor for comparing the user input data to vehicle information data; and
a display for providing equity information in a vehicle listing for marketing said vehicle to potential purchasers.

20. The system of claim 19, wherein the access to a vehicle information data base is provided over a network.

21. The system of claim 20, wherein the network comprises a proprietary database and an access to a non-proprietary data base.

22. The system of claim 21, wherein the network comprises a plurality proprietary databases and an access a non-proprietary data base.

23. The system of claim 21, wherein the network comprises a proprietary database and a plurality of accesses to non-proprietary data base.

24. The system of claim 19, wherein the display is a webpage.

25. The system of claim 24 wherein the webpage comprises a portion for displaying equity information related to an item.

26. The system of claim 24 wherein the web page comprises a portion for displaying non-propriety data.

27. The system of claim 24 wherein the webpage comprises a portion for displaying proprietary data.

28. The system of claim 24 wherein the webpage comprises a portion for advertising.

29. The system of claim 24 wherein the webpage comprises a plurality of portions for advertizing.

30. The system of claim 24 wherein the webpage comprises a portion for user history.

31. A computer readable memory having computer executable instructions comprising:
(a) receiving input from a user relating to a vehicle, wherein the user input comprises an asking price and storing said input in a storage;
(b) accessing a vehicle information database comprising retail values, trade-in values and other vehicle data averaged data;
(c) comparing said user input to the vehicle information database to determine an equity value and storing said equity value; and
(d) outputting a vehicle listing for marketing said vehicle, wherein the vehicle listing comprises the equity value.

32. The computer readable memory having computer executable instructions of claim 31 further comprising updating said averaged data at a predetermined interval.

33. The computer readable memory having computer executable instructions of claim 31 further comprising retrieving advertising data and outputting said advertizing data.

34. The computer readable memory having computer executable instructions of claim 31 further comprising outputting a plurality of vehicle listings.

35. The computer readable memory having computer executable instructions of claim 34 further comprising outputting a plurality of equity values.

35. The computer readable memory having computer executable instructions of claim 35 further comprising a range of equity values.

36. The method of claim 11, wherein the equity is calculated by subtracting an asking price contained in the vehicle listing from an average retail value.
